(19) United States
(12) Patent Application Publication
(10) Pub. No.: US 2004/0174971 A1
(43) Pub. Date: Sep. 9, 2004

(54) Adjustable profile controlled and individualizeable call management system

(76) Inventor: Qi Guan, Wien (AT)

Correspondence Address: MORRISON & FOERSTER LLP, 1650 TYSONS BOULEVARD, SUITE 300, MCLEAN, VA, 22102, US

(21) Appl. No.: 10/474,698

(22) PCT Filed: Apr. 12, 2002
(86) PCT No.: PCT/EP02/04115

(30) Foreign Application Priority Data
Feb. 12, 2001 (AT) A603/2001

(51) Int. Cl. H04M 3/42

(52) U.S. Cl. 379/201.02; 379/211.02

(57) ABSTRACT

The invention relates to the subsequent handling of forwarded calls by means of subscriber-individual, adjustable profiles. Calls for a subscriber and forwarded to a call management system (WebAMs) are subjected to subsequent handling in accordance with the call number of the terminal (TEL1) from which the call has been made. Possible subsequent handling measures include, for instance, forwarding the call to a terminal specified in the profile, sending a notification to a terminal specified in the profile and receiving and storing the call. In the case of call numbers not included in the profile, the call is handled in accordance with a default setting. In another embodiment, subscriber-individual profiles can be activated or deactivated according to a time schedule. One advantage of the invention is that it offers greater flexibility while enabling the handling of calls in line with the needs of the subscriber and user friendly modification of settings.

### CLAIM FOR PRIORITY

This application claims priority to International Application No. PCT/EP02/04115, which was published in the German language on Oct. 24, 2002, which claims the benefit of priority to Austrian Application No. A 603/2001 which was filed in the Austrian language on Apr. 12, 2001.

### TECHNICAL FIELD OF THE INVENTION

The invention relates to a call answering device, a call management system, and a method for further handling of forwarded calls.

### BACKGROUND OF THE INVENTION

The multiplicity of different transmission systems and message formats, such as fixed-network telephony, mobile telephony, Internet telephony, e-mail, and SMS message transmission, has resulted in a lack of clarity for consumers of messages. There is consequently a need for services that allow different message formats to be handled in a uniform manner. Technological advances in the linking of or collaboration among different networks, such as the Internet, the PSTN network (PSTN: Public Switched Telephone Network), and the GSM network (GSM: Global system for Mobile Communications), have led to the implementation of services for managing messages of differing format.

For example, PSTN switching systems have been equipped with a function permitting PSTN telephone calls to be forwarded as a Voice-over-IP call to an Internet terminal or a notification concerning an arrived call to be sent. This feature or functionality is known by the name Internet Call Waiting. The Internet Call Waiting service can, moreover, be enhanced with further features such as an acknowledgement to the caller or forwarding to another fixed-network telephone.

Another approach to designing user-friendly services is the Unified Messaging concept. Generally speaking, a standardized interface for different message formats is provided by the Unified Messaging concept. Messages with different formats, such as PSTN telephone calls, faxes, e-mail messages, and mobile radio telephone calls, are brought together at a single location, for example a voice portal provided by a carrier, and routed from there to the user or addressee in a standardized format. The user correspondingly sends messages in a standardized format to the interface, where format matching takes place for further transmission.

### SUMMARY OF THE INVENTION

The invention improves the flexibility of conventional systems for handling or managing messages.

The call answering device according to one embodiment of the invention has

a device for creating profiles which specify the relationships between incoming calls and reactions to these calls,

a device for specifying time ranges during which specific profiles are activated,

a device for activating profiles on a time-dependent basis,

a device for initiating the creation of messages according to the respectively activated profile, and

a device for creating messages, in particular SMS (Service Management System) messages, voicemail messages, Instant Messaging messages, and callback messages.

According to another embodiment of the invention, forwarded calls are handled in a call management system in accordance with profiles specific to individual telecommunication terminals. The profile specific to an individual telecommunication terminal is assigned to, for example, the originally called telecommunication terminal. The profile specific to an individual telecommunication terminal offers the possibility of specifying a further-processing function according to the telecommunication terminal from which the original call was made. This further-processing function can comprise the sending of a message to a telecommunication terminal or to an Internet terminal, for example a fixed-network telephone, mobile phone, Voice-over-IP telephone, personal computer or Internet terminal, or PDA (Personal Digital Assistant). There can be a provision in the call management system according to the invention for specifying a default setting for calls forwarded from telecommunication terminals for whose call numbers no further-processing functions are explicitly specified. The call management system according to the invention has the advantage that the handling of forwarded calls can be differentiated depending on the calling terminal. For example, business calls can be handled differently to private calls. Calls from terminals for which no handling has been explicitly specified are handled in accordance with a default setting. This gives users of the call management system greater flexibility in terms of the handling of calls directed at them and forwarded. This flexibility will be further increased if it is possible to create new profiles and modify existing ones on a need basis by, for example, the call management system user's setting up an Internet connection to the call management system and being able to perform said modifications over this connection.

The system according to the invention differs from systems based on the ITU standard ITU-T Q.732.2 for the forwarding of calls. With the cited standard, when calls are forwarded via several terminals or locations, the call is handled in each case in accordance with the number of the last telecommunication terminal or last location in the chain. According to the invention, further-processing functions can be set according to the identity of the originally calling terminal. This provides possibilities for managing forwarded calls considerably more flexibly. The invention allows individual call handling based on parties' needs and user-friendly modification of the settings by changing the profiles.

An alternative embodiment for increasing flexibility is the option of assigning several profiles to a telecommunication terminal call number, that is to a user of the call management system, with the possibility of activating or deactivating the assigned profiles according to a time-clocking function. Users are able, for instance, to specify time ranges during which a specific profile is to be activated or deactivated. They can, for example, specify a different profile for the weekend or for their vacation times, and thus different handling of forwarded calls, from the profile applicable during the working week. A further processing function offered for vacation times, for example, is the non-forwarding and recording of calls forwarded to the management system. As an optional provision in the call management system, users can be informed about the further handling of arrived forwarded calls via a transmitted message. The term ‘notification’ as employed below is intended in the sense that a notification contains information regarding the fact of a forwarded call but does not contain any content-related information about this forwarded call. The term ‘message’ is intended as referring to messages with content-related information and notifications. Possible further-processing functions are the sending of a message with the content of a forwarded call or of a notification together with the arrived call to an Internet terminal or telecommunication terminal, forwarding of the call to a telecommunication terminal, or recording of the call in the call management system or data processing device. The message or notification can comprise voice or text information. For a forwarded telephone call there are the possibilities of forwarding a message issued by the caller or a message spoken onto tape, sending a notification about the arrived call, recording an issued message without forwarding of the message or any notification, or registering the message, for example with registration information such as the caller's telephone number and the time of the call. The call management system can forward a message or notification over different types of networks such as packet-based networks (Internet), fixed networks, or mobile networks. Provided the terminal is equipped with the appropriate functions, voice or text information can in all these cases be transmitted by means of the message or notification. Examples are messages in the form of e-mail, voicemail of a Voice-over-IP telephone call, fixed-network telephone call, fax transmission, mobile phone call, and SMS message. One possibility is to create a pop-up window with the aid of a software agent in an Internet terminal and so visualize the message or notification on the screen. This function can be realized

for example with the aid of the Java programming language. The activation and deactivation of profiles according to a time-clocking function can be realized, in one embodiment, in the following manner:

The user or operator of the call management system produces a time schedule divided into time periods during which in each case an individual profile specific to a telecommunication terminal is to be activated. According to this division into time periods, a check is then performed at intervals determined by the timing function to establish whether profiles are to be activated or deactivated. At the end of a time period or at the start of the next time period the old profile is deactivated and a new profile activated. If no new profile has been specified for activation at the end of a time period but the old profile has to be deactivated, a profile specified as the default setting is activated. In addition to this “automatic” profile activation it is also possible to provide “manual” profile activation, with the user, for example, connecting to the call management system over the Internet and, over this connection, specifying the profile to be activated. Provision can then be made for deactivating “automatic” profile modifications provided during a selectable period of time.

A call arriving at the call management system can also be checked to determine whether it is a forwarded call before the currently activated associated-profile specific to the telecommunication terminal is determined and before a further-processing function is specified in accordance with the call number of the telecommunication terminal from which the call was made or in accordance with a default setting. A further possible provision is to specify or indicate several further-processing functions instead of a single such function. This will enable users, for instance, to ensure that an important telephone call is forwarded to a number of their terminals. In the call management system according to the invention or in the method according to the invention, provision can be made for supplying the original callers with a voice message, or for using an IVR (interactive voice response) functionality, in order, for example, to inform them about the forwarding of the call or about the called party's non-availability and/or to prompt them to leave a spoken message on tape. The processing of forwarded messages by the call management system according to the invention is not restricted to PSTN calls. The calls can equally be, for instance, calls from a mobile phone, a VoIP (Voice over IP) terminal, or an Internet terminal with appropriate voice functionality.

### BRIEF DESCRIPTION OF THE INVENTION

The invention is explained in greater detail below with the aid of exemplary embodiments.

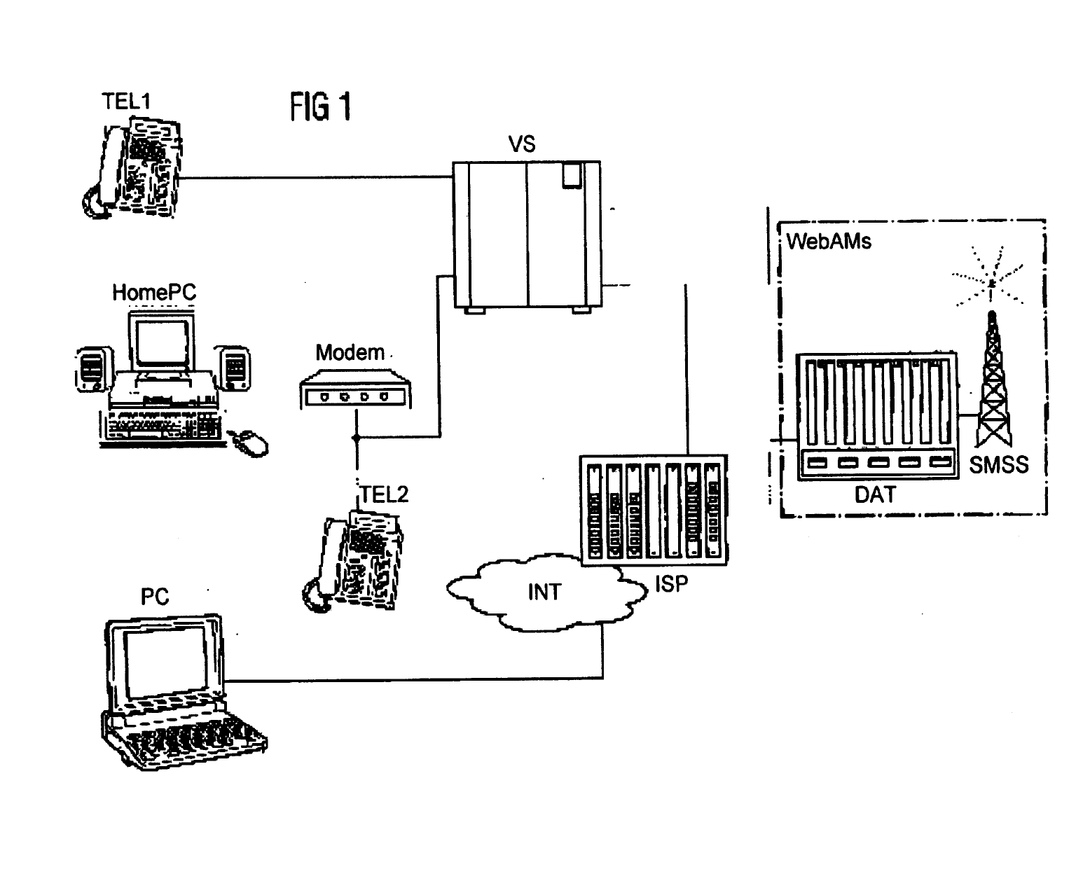

FIG. 1 is a schematic representation of the terminals and circuitry in the call management system according to the invention.

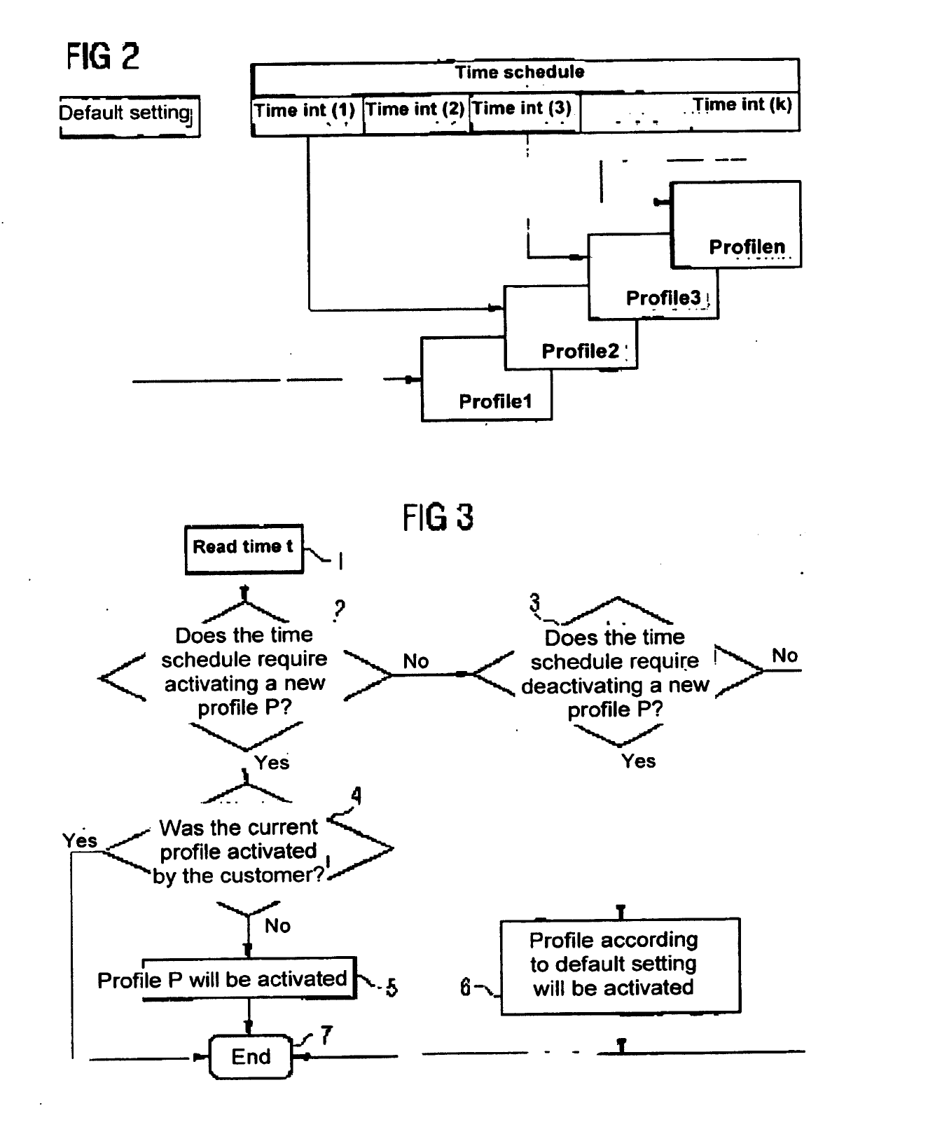

FIG. 2 clarifies the use of profiles according to a timing function.

FIG. 3 shows a flowchart for profile activation.

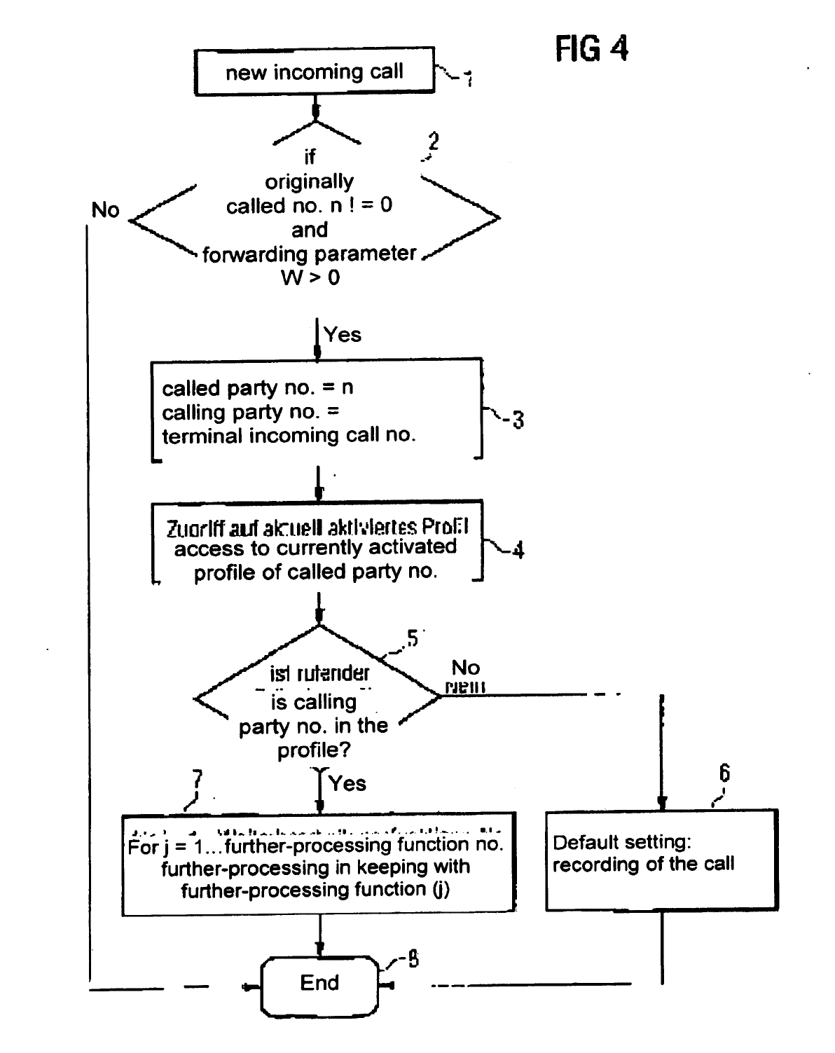

FIG. 4 shows a flowchart for initiating further-processing functions for newly arriving calls.

### DETAILED DESCRIPTION OF THE INVENTION

FIG. 1 shows a telephone TEL1 via which a call is initiated. Within the called party's area of responsibility is a telephone TEL2 and a personal computer HomePC which is connected via a modem to a switching system VS. The two telephones TEL1 and TEL2 are also connected to the switching system VS. It is possible to exchange information via the switching system VS, with the call management system WebAMs according to the invention being provided in the exemplary embodiment by means of a data processing device DAT and a sender SMSS for sending Short Message Service (SMS) messages. The switching system VS and the call management system WebAMs are connected to an Internet service provider ISP permitting access to the Internet INT. A further portable personal computer PC is connected to the Internet INT. A function for extending calls to the call management system WebAMs is activated in order to access the services of the call management system WebAMs. To activate call forwarding to the call management system WebAMs, users of the call management system WebAMs for example enter a data combination and a call number assigned to the call management system WebAMs on their telephone TEL2. To specify further-processing functions, users of the call management system WebAMs can, for example, connect to the call management system WebAMs over the Internet INT and configure or activate profiles. When a call is forwarded to the call management system WebAMs, a further-processing function is activated as a function of the activated profile and of the call number of the telecommunication terminal TEL1 from which the call was made. Three examples of activating further-processing functions are explained in greater detail below. In the first example the called party is connected to the Internet INT. An Internet connection is set up to the call management system WebAMs in order to be informed about arriving calls during the Internet session. As part of this Internet connection, a pop-up window is activated on the Internet terminal PC of the user of the call management system WebAMs. In the event of a call's being forwarded to the call management system, the call management system WebAMs issues a message to the calling party or to his/her terminal TEL1 to inform him/her that his/her call has been forwarded. The calling party is then able to speak a message which is recorded by the call management system WebAMs. If there is an appropriate entry in the activated profile, the message will be transmitted to the Internet terminal PC and fed out there as a voice or text message. In a further example the called party is not accessible via either telephone TEL2 or the Internet INT. According to the first example the calling party can place a message with the call management system WebAMs which will be recorded. According to the activated profile, this message will be transmitted to the called party's mobile phone, for example as an SMS message. In a third example the message produced by the calling party will be recorded and can be listened to via a fixed-network telephone or mobile phone or over the Internet. These three examples illustrate the functions of the elements shown in FIG. 1. It means the called party's personal computer HomePC can be used to receive a message placed with the call management system WebAMs or to obtain a notification about a message recorded there, or to retrieve messages recorded on the call management system WebAMs. Users of the call management system WebAMs are not obliged here to employ a specific personal computer HomePC for retrieving received messages. They can also, for example, connect to the call management system WebAMs over the Internet from any location using a portable computer in order to listen to messages that have arrived. In doing this they can also access a log of messages that have arrived. They can alternatively listen to received messages on a telephone.

FIG. 2 clarifies how profiles profile1 . . . profilen are activated according to a timing function. The profile profile1 will remain active as the default setting unless another profile is activated as part of the time-dependent activation of new profiles. A new profile is activated at specific times in accordance with the setting made by the user of the call management system WebAMs. A check is performed here at regular intervals according to a timing function to determine whether a new profile has to be activated and, where applicable, a new profile is activated. A simple application would be for the user of the call management system WebAMs to have activated a profile at the weekend that is different from the one activated during the week or for a user, during a business trip, to have activated a profile by means of which important calls will be forwarded to his/her mobile phone.

In FIG. 3, the decision processes involved in activating a new profile are illustrated with the aid of a flowchart. The time is taken at regular intervals. A check is performed at the times taken to determine whether a new profile is awaiting activation. If a new profile has to be activated, a check is performed to determine if the current profile has not been activated by the user or as part of the timing function. If the current profile has been activated as part of the timing function, it will be replaced by the new profile. If no new profile has to be activated at the time specified by the timing function, a check is performed to determine if the current profile has to be deactivated. If the current profile has to be deactivated, the profile specified by the default setting will then be activated. The individual steps shown in the figure are:

1: A time specified by a timer is read.

2: Decision query: Does the time schedule require the activation of a new profile? Step 3 follows if the response is negative; step 4 follows if the response is positive.

3: Decision query: Does the time schedule require the current profile to be deactivated? Step 7 follows if the response is negative; step 6 follows if the response is positive.

4: Decision query: Has the current profile been “manually” activated by the customer or user? Step 5 follows if the response is negative; step 7 follows if the response is positive. An additional check is performed, if necessary, to establish if the user has performed an activation within a period of time that can be specified. In this way it is possible to leave out of account any “manual” modifications that were made too long before.

5: Activation of the new profile to be activated.

6: Activation of the profile specified by the default setting.

7: End.

In FIG. 4, the processes and decisions that are carried out by the call management system WebAMs in processing a newly arrived call are illustrated with the aid of a flowchart. A check is performed in the case of a newly arrived call to establish if the originally called number has been assigned to a user of the call management system WebAMs and whether the incoming call has been forwarded. If the call is one forwarded to a user of the call management system WebAMs, the currently activated profile assigned to the originally called number or to the user will be called up. A check is performed to determine whether one or more further-processing—functions have been specified for the number of the calling party in the profile. If no further-processing functions have been specified for the caller's call number, the further-processing function according to the default setting, such as recording of the call, will be launched. If further-processing functions have been specified for the telephone number, the call will be handled further in accordance with these further-processing functions. The individual steps are as follows:

1: A new call reaches the management system.

2: Decision query: Information about the arrived call is evaluated. If the parameter for the originally called number has been set and the call is a forwarded call according to the parameter W for the forwarding of calls, step 3 follows. Step 8 otherwise follows.

3: Parameter assignment: The numbers of the originally called party and of the calling party are registered. Step 4 follows.

4: The profile activated for the number of the originally called party is determined. Step 5 follows.

5: Decision query: Has at least one further-processing function been specified for the calling party's number? Step 6 follows if the response is negative, otherwise step 7.

6: The forwarded call will be handled in accordance with the further-processing function specified in the default setting, such as recording of the call. Step 8 follows.

7: Loop via the further-processing functions specified for the calling party's number. The further-processing measures corresponding to these further-processing functions will be performed. Step 8 follows.

8: End.

1. Call answering device with
means for creating profiles which specify the relationships between incoming calls and reactions to these calls,
means for specifying time ranges during which specific profiles are activated,
means for activating profiles on a time-dependent basis,
means for initiating the creation of messages according to the respectively activated profile, and
means for creating messages, in particular SMS messages, voice-mail messages, Instant Messaging messages, and callback messages.

2. Call management system for forwarded calls which has a data processing device,
characterized in that
a profile, specific to an individual telecommunication terminal, for controlling the further handling of forwarded calls has been created in the data processing device, wherein
a further-processing function can be specified in the profile specific to an individual telecommunication terminal according to the call number of the telecommunication terminal from which the original call was made, and
the sending of a message to a telecommunication terminal or an Internet terminal can be specified as a further-processing function.

3. Call management system according to claim 2,
characterized in that
it is possible to establish a default setting for the further-processing function applying to calls forwarded from telecommunication terminals for whose call numbers no further-processing functions have been specified.

4. Call management system according to claims 2 and 3,
characterized in that
new profiles can be created and existing profiles modified on a need basis,
a telecommunication terminal call number can be assigned a plurality of profiles, and
the profiles assigned to a telecommunication terminal call number can be activated or deactivated according to a time-clocking function.

5. Call management system according to one of the preceding claims 2 to 4,
characterized in that
the forwarded calls can be recorded by the call management system, and
the non-forwarding and recording of the forwarded call can be specified as a further-processing function.

6. Call management system according to one of the preceding claims 2 to 5,
characterized in that
a message providing information about further processing can be transmitted by the call management system to the telecommunication terminal from which the forwarded call was made.

7. Call management system according to one of the preceding claims 2 to 6,
characterized in that
it is possible to specify as a further-processing function the sending of a message with the content of a forwarded call or a notification about the arrived call to an Internet terminal or telecommunication terminal, the forwarding of the call to a telecommunication terminal, or the recording of the call in the data processing device, with the message or notification containing voice or text information.

8. Call management system according to claim 7,
characterized in that
the notification comprises a Short Message Service (SMS) message sent to a mobile phone or can be visualized on the screen of an Internet terminal with the aid of a pop-up window controlled by an agent.

9. Call management system according to one of the preceding claims 2 to 8,
characterized in that
a connection can be set up from an Internet terminal to the call management system for the purpose of modifying a profile specific to an individual telecommunication terminal or for creating a new profile.

10. Call management system according to one of the preceding claims 2 to 9,
characterized in that
the call management system has a sender for Short Message Service (SMS) messages.

11. Method for further handling of forwarded calls with the aid of a call management system which is stored in a data processing device and is executable,
characterized in that
a call is forwarded to the call management system according to a setting of the called telecommunication terminal,
a message transmitted by means of the call is registered,
a further-processing function is specified according to the call number of the telecommunication terminal from which the forwarded call was made by means of a profile specific to an individual telecommunication terminal, and
according to the further-processing function a message with the content of a forwarded call or a notification about the arrived call is transmitted to an Internet terminal or a telecommunication terminal and the call is forwarded to a telecommunication terminal or recorded in the data processing device.

12. Method according to claim 11,
characterized in that
all incoming calls are registered.

13. Method according to claim 11 or 12,
characterized in that
a voice message for informing the caller is issued when a call forwarded to the call management system is accepted.

14. Method according to claims 11 to 13,
characterized in that
each message registered in the case of a forwarded call for which a further-processing function is specified is recorded in the data processing device.

15. Method according to one of the claims 11 to 14,
characterized in that
a message or notification transmitted according to a further-processing function contains voice information or text information.

16. Method according to one of the claims 10 to 15,
characterized in that
a connection is set up from an Internet terminal or a telecommunication terminal to the call management system, and
the content of a recorded call or registration information about arrived calls is called up by the call management system with the aid of the connection in the Internet terminal or telecommunication terminal.

17. Method according to one of the claims 11 to 16,
characterized in that
a connection is set up to an Internet terminal or telecommunication terminal, and
a new profile is created, an existing profile modified, or an existing profile activated from the Internet terminal or telecommunication terminal.

18. Method according to claim 17,
characterized in that
a new profile is assigned to a telecommunication terminal call number.

19. Method according to one of the claims 11 to 18,
characterized in that
the profiles which are specific to an individual telecommunication terminal and are assigned to a telecommunication terminal call number are activated or deactivated according to a time-clocking function.

20. Method according to claim 19,
characterized in that
a check is performed at intervals specified according to the time-clocking function in order to determine whether a new profile has to be activated according to a division, which can be set as part of a time schedule, into time periods during which in each case a profile specific to an individual telecommunication terminal has to be activated,
if a new profile has to be activated the activated profile is deactivated and the new profile is activated,
in the absence of a profile to be activated a check is performed to determine whether a profile has to be deactivated, and
if a profile has to be deactivated the profile is deactivated and a profile specified as the default setting is activated.

21. Method according to claim 20,
characterized in that
if a profile specific to an individual telecommunication terminals has to be activated, the profile will not be activated if, over an Internet connection or by telephone, a profile activation has been effected which differs from the activation of profiles as part of the division corresponding to the time schedule.

22. Method according to one of the claims 11 to 21,
characterized in that
an incoming call is checked to verify that it is a forwarded call,
the currently activated profile which is specific to an individual telecommunication terminal and which is assigned to the telecommunication terminal from which the call was forwarded is determined,
a check is performed to determine if at least one further-processing function has been specified in the profile for the call number of the telecommunication terminal from which the call was made,
if a further-processing function has been specified the call will be handled in accordance with the further-processing function or further-processing functions, and
in the absence of specified further-processing functions the call will be handled in accordance with a further-processing function given as the default setting.

23. Method according to one of the claims 11 to 22,
characterized in that
the message or notification in the case of transmission to an Internet terminal comprises an e-mail or voicemail, is sent by means of voice transmission over the Internet, or is visualized on the screen of an Internet terminal with the aid of a pop-up window controlled by an agent, and
the message, notification, or forwarded call in the case of transmission to a fixed-network telephone or mobile phone is transmitted with the aid of the PSTN or, in the case of a mobile phone, comprises a Short Message Service (SMS) message.
